(19) United States
(12) Patent Application Publication
(10) Pub. No.: US 2010/0248617 A1
(43) Pub. Date: Sep. 30, 2010

(54) MOBILE TELECOMMUNICATIONS

(76) Inventor: Alan Law, Hampshire (GB)

Correspondence Address: MUIRHEAD AND SATURNELLI, LLC, 200 FRIBERG PARKWAY, SUITE 1001, WESTBOROUGH, MA, 01581, US

(21) Appl. No.: 12/312,260

(22) PCT Filed: Oct. 18, 2007
(86) PCT No.: PCT/GB2007/003973

§ 371 Date: May 3, 2010

(30) Foreign Application Priority Data
Nov. 3, 2006 (GB) 0621961.2

(51) Int. Cl. H04B 7/15

(52) U.S. Cl. 455/11.1

(57) ABSTRACT

Cellular mobile terminals in an aircraft may communicate with terrestrially located base stations via a base station and antenna arrangement carried by the aircraft. A control unit adjusts the size and/or shape of the radiation beam emitted by the antenna arrangement in dependence on the altitude of the aircraft so that the beam footprint always covers a desired number of the base stations. A location-responsive control unit adjusts the size and/or shape of the beam in dependence on the horizontal position of the aircraft over the earth so that the beam footprint is larger when the aircraft is over regions where the base stations are more sparsely located. Each base station may be associated with a control unit responsive to signals indicative of the altitude and the horizontal position of aircraft over the earth so as to adjust the size and/or shape of the beam emitted by the base station.

### FIELD OF THE INVENTION

The invention relates to mobile telecommunications systems and methods. Embodiments of the invention, to be described in more detail below by way of example only, enable radio telecommunication between a user on a mobile platform such as an aircraft and a terrestrial location. More specifically, such systems and methods enable cellular radio communication between a user terminal on an aircraft and a terrestrial location.

### BACKGROUND TO THE INVENTION

In mobile cellular telecommunications systems, user terminals establish communication links via base stations, each of which is particular to a specific geographical region (although the regions may overlap). If a user terminal has established a communication link via a particular base station and then moves out of the region of that base station into the region of another base station, the link is handed over to the new base station without interruption of the communication. When cellular user terminals are used in aircraft, particular problems may arise, and embodiments of the invention to be described below are concerned with these problems.

### SUMMARY OF THE INVENTION

According to the invention, there is provided a telecommunications system for establishing a wireless radiation link between any one or more of a plurality of user terminals movable in aerospace and any one or more of a plurality of terrestrially based transceiving stations, comprising at least one antenna arrangement for producing a radiation beam for providing the link, and control means operative in response to the position of the user terminal in aerospace to adjust the size and/or the shape of the beam in dependence on that position.

According to the invention, there is also provided a telecommunications method for establishing a wireless radiation link between any one or more of a plurality of user terminals movable in aerospace and any one or more of a plurality of terrestrially based transceiving stations, comprising the steps of producing a radiation beam for providing the link, and adjusting the size and/or the shape of the beam in dependence on the position of the user terminal in aerospace.

According to the invention, there is further provided a cellular telecommunications network, comprising a plurality of mobile user terminals arranged to establish radio links with the network between themselves and terrestrially located base stations, in which some of the user terminals are carried in an aircraft having an antenna arrangement for emitting a radio beam towards the earth for use in establishing the link, the antenna arrangement being associated with control means responsive to the position of the aircraft relative to the earth for adjusting the size and/or shape of the beam in dependence thereon to optimise its reception by a particular one or ones of the base stations.

### BRIEF DESCRIPTION OF THE DRAWINGS

For a better understanding of the invention, embodiments thereof will now be described by way of example, with reference to the accompanying diagrammatic drawings, in which:

FIG. 1 is a drawing of key elements of a mobile cellular telecommunications network (a GSM network in particular) for use in explaining the operation of such a network; and

FIG. 2 shows the operation of a system embodying the invention.

In the drawings, like elements are generally designated with the same reference sign.

### DETAILED DESCRIPTION OF EMBODIMENTS OF THE INVENTION

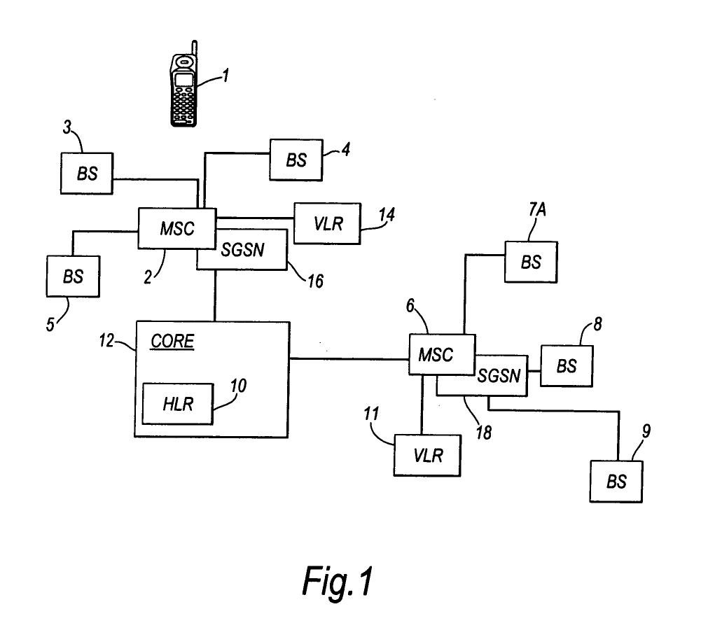

Key elements of a mobile telecommunications network, and its operation, will now briefly be described with reference to FIG. 1.

Each base station (BS) corresponds to a respective cell or geographical area of its cellular or mobile telecommunications network and receives calls from and transmits calls to a mobile user terminal in that cell by wireless radio communication in one or both of the circuit switched or packet switched domains. Such a subscriber's mobile user terminal is shown at 1. The mobile terminal may be a handheld mobile telephone, a personal digital assistance (PDA) or a laptop computer equipped with a datacard, for example.

In a GSM mobile telecommunications network, each base station comprises a base transceiver station (BTS) and a base station controller (BSC). A BSC may control more than one BTS. The BTSs and BSCs comprise the radio access network.

In a UMTS mobile telecommunications network (not illustrated), each base station comprise a node B and a radio network controller (RNC). An RNC may control more than one node B. The node B's and RNC's comprise the radio access network.

Conventionally, the base stations are arranged in groups and each group of base stations is controlled by one mobile switching centre (MSC), such as MSC 2 for base stations 3,4 and 5. As shown in FIG. 1, the network has another MSC 6, which is controlling a further three base stations 7,8 and 9. In practice, the network will incorporate many more MSCs and base stations than shown in FIG. 1.

Each subscriber to the network is provided with a smart card or SIM which, when associated with the user's mobile user terminal, identifies the subscriber to the network. The SIM card is pre-programmed with a unique identification number, the “International Mobile Subscriber Identity” (IMSI), which is not visible on the card and is not known to the subscriber. The subscriber is issued with a publicly known number, that is, the subscriber's telephone number, by means of which calls to the subscriber are initiated by callers. This number is the MSISDN.

The network includes a home location register (HLR)/home subscriber server (HSS) 10 which, for each subscriber to the network, stores the IMSI and the corresponding MSISDN together with other subscriber data, such as the current or last known location of the subscriber's mobile terminal.

When the subscriber wishes to activate their terminal in a network (so that it may make or receive calls subsequently), the subscriber places their SIM card in a card reader associated with the mobile terminal (terminal 1 in this example). The mobile terminal 1 then transmits the IMSI (read from the card) to the base station 3 associated with the particular cell in which the terminal 1 is located. The base station 3 then transmits this IMSI to the MSC 2 with which the BS 3 is registered.

MSC 2 now accesses the appropriate location in the HLR 10 present in the network core (CN) 12 and extracts the corresponding subscriber MSISDN and other subscriber data from the appropriate storage location, and stores it temporarily in a location in a visitor location register (VLR) 14. In this way, therefore, the particular subscriber is effectively registered with a particular MSC (MSC 2), and the subscriber's information is temporarily stored in the VLR (VLR 14) associated with that MSC.

When the HLR 10 is interrogated by the MSC 2 in the manner described above, the HLR 10 additionally performs an authentication procedure for the mobile terminal 1.

Each of the MSCs of the network (MSC 2 and MSC 6) has a respective VLR (14 and 11) associated with it and operates in the same way as already described when a subscriber activates a mobile terminal in one of the cells corresponding to one of the base stations controlled by that MSC.

When the subscriber using mobile terminal 1 wishes to make a call, having already inserted the SIM card into the reader associated with this mobile terminal, and the SIM has been authenticated in the manner described, a call may be made by entering the telephone number of the called party in the usual way. This information is received by the base station 3 and is then routed to the called party via the MSC 2. By means of the information held in the VLR 14, MSC 6 can associate the call with a particular subscriber and thus record information for charging purposes.

The MSCs 2 and 6 support communications in the circuit switched domain—typically voice calls. Corresponding SGSNs 16 and 18 are provided to support communications in the packet switched domain—such as GPRS data transmissions. The SGSNs 16 and 18 function in an analogous way to the MSCs 2 and 6. The SGSNs 16,18 are equipped with an equivalent to the VLR for the packet switched domain.

From the description above, it will be understood that the coverage area of a mobile telecommunications network is divided into a plurality of cells, each of which is served by a respective base station. In order to allow a mobile terminal to maintain a call when the mobile terminal moves outside the coverage area of a cell, the call must be switched to an alternative cell automatically. The call must be routed to the new cell before handover can be effected whilst maintaining the connection with the old cell until the new connection is known to have succeeded. Handover is a time-critical process requiring action to be taken before the radio link with the original cell degrades to such an extent that the call is lost. Handover requires synchronization of events between the mobile terminal and the network.

Handover between two cells served by the same MSC/SGSN is relatively straightforward (this is referred to as “soft handover”). The handover process is more complex when a mobile terminal moves between a first cell served by a first MSC/SGSN and a second cell served by a second MSC/SGSN (this is referred to as a “hard handover”). The VLRs of the MSCs/SGSNs and the HLR additionally have to be updated to reflect that the mobile terminal is now in a cell served by the second MSC/SGSN.

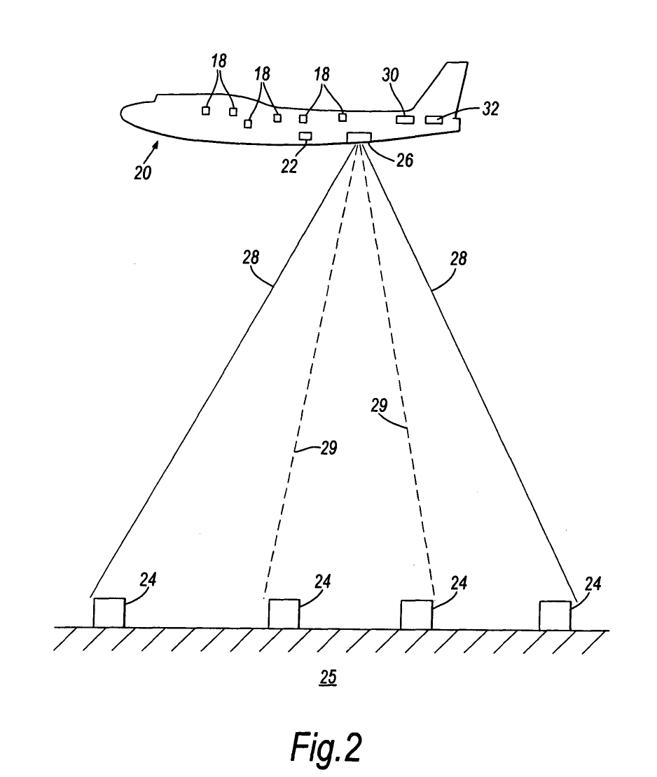

In the embodiments to be described, user terminals 18 are to be used in an aircraft 20 (FIG. 2), to enable users to communicate with terrestrially based user terminals (fixed or mobile) or with user terminals on other aircraft. Thus, in a manner to be described, a transport network is set up so that each user terminal in the aircraft can establish a cellular telecommunications link with its cellular network in the same way as if it were terrestrially based rather than in the aircraft.

The aircraft carries a base station 22 with which all the user terminals on the aircraft can communicate; the communication link between each user terminal and the base station 22 can be by radio or other wireless method or by a wired connection (such as, for example, from each seat on the aircraft to the base station 22).

In order to enable the user terminal on the aircraft to link with the terrestrial cellular network (and thence to other user terminals whether part of that network or not), base stations 24 are provided at suitable geographical locations on the earth 25, or at least along the expected flight path of the aircraft. Each base station 24 is generally of the form described above with reference to FIG. 1 and is associated with an antenna arrangement for receiving and transmitting radio signals. However, it is modified so as to transmit and receive radio signals in upward and downward directions. In the case of a base station used for terrestrially based user terminals, its radio signals are primarily transmitted and received in a generally horizontal direction.

In order to establish the transport network between the aircraft and the earth, and thus to enable radio communication between the base station 22 in the aircraft and the base stations 24 on the earth, the aircraft will carry an antenna arrangement indicated diagrammatically at 26. The antenna arrangement 26 emits radiation with a particular beam size and shape, such as a cone-shaped beam shown by the full lines 28 in FIG. 2, thus providing a “beam footprint” of specific size on the earth. Thus, the footprint will cover a particular geographical area on the ground. If the area of this footprint is so large that it encompasses a significant number of the base stations 24, then it is unlikely that the system will operate satisfactorily—because a significant number of the base stations will receive signals from the aircraft of substantially the same strength and it is unlikely that any one of the base stations would be able to establish a proper communications link with the base station 22 in the aircraft. Furthermore, in such an example the radio beam from the antenna arrangement 26, being distributed over a large area, would have a low strength at any particular point. It is therefore highly desirable that the radio beam from the antenna arrangement 26 should have a suitably defined footprint so that signals are only received by a restricted number of the base stations 24. In some circumstances, the footprint should be such that the signals are received only by a single base station. More usually, though, the beam footprint should be such that the radio signals are received by more than one, preferably two, of the base stations as the aircraft moves through the air. Under such circumstances, a radio link would be established between the unit 22 and one of these two base stations (via the antenna arrangement 26, of course) initially. Then, as the aircraft continues its flight path, the communication link would be handed over to the other of these base stations in the manner described with reference to FIG. 1.

However, if the radio beam emitted by the antenna arrangement 26 is adjusted so that it has the size and shape shown in FIG. 2 by the dotted lines 29, thus achieving the desired aim of covering only two of the base stations 24, it will be apparent that changes in the height of the aircraft above the earth will alter the size of the beam's footprint in an unsatisfactory way. If the size and shape of the radio beam is established so that, at a particular aircraft height, the footprint of the beam covers the desired number of base stations (for example, two, as shown by the lines 29), then if the altitude of the aircraft increases significantly, the beam footprint is likely to cover a greater number of base stations. As already explained, this is likely to cause unsatisfactory operation of the system because several of the base stations will receive signals of substantially the same strengths. Similarly, if the altitude of the aircraft is reduced, then the beam footprint may no longer cover two of the base stations 24.

In order to deal with this problem, the antenna arrangement 26 is arranged to be adjustable so as to vary the size and shape of its emitted beam and, in particular, to vary the footprint of the beam when it reaches the earth. In addition, the aircraft is provided with a height-responsive unit 30 which monitors the altitude of the aircraft and adjusts the antenna arrangement 26 accordingly, so as to maintain a desired size and shape of the emitted beam and thus provide a desired footprint of the beam on the earth.

For example, the height-responsive unit 30 could be arranged to adjust the antenna arrangement 26 in dependence on the altitude of the aircraft so that, irrespective of the aircraft's altitude, the beam footprint was always the same.

In practice, though, it may be desirable to vary the beam footprint according to the horizontal position of the aircraft over the earth. Thus, in some geographical regions of the earth (sparsely populated regions in particular) the base stations 24 may be widely spaced. When the aircraft is flying over such regions, the beam footprint needs to be relatively large so as to cover two, say, of the base stations. In other geographical regions of the earth, the base stations 24 may be much closer together (over densely populated regions, for example) and the beam footprint must be much smaller to avoid the problems, as already discussed, where the beam covers a multitude of the base stations. Therefore, the aircraft is provided with a location-responsive unit 32 which is responsive to the horizontal position of the aircraft over the earth and adjusts the antenna arrangement accordingly. In such a case, therefore, the height-responsive unit 30 and the location-responsive unit 32 act together so that the size and shape of the beam emitted by the antenna arrangement 26 provides the desired footprint on the ground, taking account of the altitude of the aircraft and its horizontal position over the earth.

The height-responsive unit 30 and the location-responsive unit 32 may have any suitable form. In particular, they may be responsive to GPS signals derived from the aircraft's GPS system.

The size and shape of the beam emitted by the antenna arrangement 26 may be adjusted in any suitable way. For example, the antenna arrangement may have an adjustable phase array. Instead, it could be adjusted by means of a physical shield, like a wave guide.

The base station 22 in the aircraft may operate essentially as a repeater station in the transport network between the aircraft and the earth—that is, it simply passes signals between the user terminals in the aircraft and the relevant earth-located base station. However, in other circumstances, there may need to be more than one base station 22 in the aircraft (for example, because of the size of the aircraft or the number of user terminals carried), with handover of the user terminals between these base stations taking place.

The foregoing description has been concerned with the transmission of signals from the aircraft to the earth-located base stations. The transport network between the aircraft and the earth also, of course, requires transmission of signals in the reverse direction. In most cases, transmissions received by the aircraft from the particular one of the earth-located base stations which is vertically (or most nearly vertically) below the aircraft will be received at a significantly greater signal strength than those received from the adjacent base stations—because the signals received from the adjacent base stations will be received at a more oblique angle. Therefore, the system described automatically achieves optimisation of capacity on both the uplink and the downlink with the aircraft. However, it would also be possible to adjust the size and shape of the radiation beam emitted by a particular one of the earth-located base stations in order to improve the establishment of an effective communications link with the base station 22 of an aircraft flying at a particular altitude. This could be achieved by arranging for the base station 22 on the aircraft to transmit a signal specifying the altitude of the aircraft which would then be used by control means associated with the earth-located base station to adjust its antenna arrangements and thus to change the size and shape of its emitted radiation beams. Thus, for example, this process could adjust the size and shape of the beam emitted by the earth-located base station so as to reduce its footprint on the aircraft 22 and thus increasing the received signal strength as compared with that of the adjacent beams from the other adjacent earth-located base stations.

It will be apparent that the systems described are not only applicable to aircraft but to other aerospace vehicles.

1. A telecommunications system for establishing a wireless radiation link between any one or more of a plurality of user terminals movable in aerospace and any one or more of a plurality of terrestrially based transceiving stations, comprising:
at least one antenna arrangement for producing a radiation beam for providing the link; and
a control unit operative in response to a position of a user terminal in aerospace to adjust at least one of: a size and a shape of the beam in dependence on the position of the user terminal.

2. The system according to claim 1, wherein the control unit is responsive to an altitude of the user terminal.

3. The system according to claim 1, wherein the control unit is responsive to a horizontal position of the user terminal over the earth.

4. The system according to claim 1, wherein the at least one antenna arrangement is in aerospace with the user terminal and the adjustment of the at least one of: the size and the shape of the beam from the antenna arrangement by the control unit is such as to adjust a terrestrial footprint of the beam.

5. (canceled)

6. The system according to claim 4, wherein the control unit is in aerospace with the antenna arrangement and the user terminal, and the control unit is responsive to GPS signals indicative of the position of the user terminal in aerospace.

7. The system according to claim 1, wherein the at least one antenna arrangement is terrestrially based with a particular one of the transceiving stations and the adjustment of the at least one of: the size and the shape of the beam from the antenna arrangement by the control unit is such that the beam is directed for establishing the link with a particular one of the user terminals.

8. The system according to claim 7, wherein the control unit is associated with the particular one of the transceiving stations and receives signals indicative of the position of the particular one of the user terminals in aerospace.

9. (canceled)

10. The system according to claim 1, wherein the user terminals are aircraft-borne.

11. The system according to claim 10, wherein a particular group of the user terminals are all carried by the same aircraft, and wherein a transceiving station is carried by the aircraft and by means of which the link between the user terminals of the group and one or ones of the terrestrially based transceiving stations is established.

12. The system according to claim 11, wherein the user terminals and the transceiving stations are part of a cellular mobile communications network.

13. The system according to claim 12, wherein, at least one of the following:
the terrestrially based transceiving stations are base stations in the cellular mobile communications network; and
the transceiving station in the aircraft is a base station in the cellular mobile communications network.

14. (canceled)

15. A telecommunications method for establishing a wireless radiation link between any one or more of a plurality of user terminals movable in aerospace and any one or more of a plurality of terrestrially based transceiving stations, comprising:
producing a radiation beam for providing the link; and
adjusting at least one of: a size and a shape of the beam in dependence on a position of a user terminal in aerospace.

16. The method according to claim 15, wherein the at least one of: the size and the shape of the beam is adjusted in response to an altitude of the user terminal.

17. The method according to claim 15, wherein the at least one of: the size and the shape of the beam is adjusted in response to a horizontal position of the user terminal over the earth.

18. The method according to claim 15, wherein the adjustment of the at least one of: the size and the shape of the beam is such that the beam is directed for establishing the link with a particular one or ones of the transceiving stations.

19. The method according to claim 15, wherein the adjustment of the at least one of: the size and the shape of the beam is such as to adjust a terrestrial footprint of the beam.

20-22. (canceled)

23. The method according to claim 15, wherein the user terminals are aircraft-borne.

24. The method according to claim 23, wherein a particular group of the user terminals are all carried by the same aircraft and in which there is a transceiving station carried by the aircraft and by means of which the link between the user terminals of the group and one or ones of the terrestrially based transceiving stations is established.

25. The method according to claim 24, wherein the user terminals and the transceiving stations are part of a cellular mobile communications network.

26. The method according to claim 25, wherein, at least one of the following:
the terrestrially based transceiving stations are base stations in the cellular mobile communications network, and
the transceiving station in the aircraft is a base station in the cellular mobile communications network.

27. (canceled)

28. A cellular telecommunications network, comprising:
a plurality of mobile user terminals arranged to establish radio links with the network between themselves and terrestrially located base stations, wherein some of the user terminals are carried in an aircraft having an antenna arrangement for emitting a radio beam towards the earth for use in establishing the links, and wherein the antenna arrangement is associated with a control unit responsive to the position of the aircraft relative to the earth for adjusting at least one of: a size and a shape of the beam in dependence on the position of the aircraft relative to the earth in connection with reception of the beam by a particular one or ones of the base stations.

29. The network according to claim 28, wherein the control unit is responsive to at least one of: an altitude of the aircraft, a horizontal position of the aircraft over the earth, and GPS signals indicative of a position of the aircraft in space.

30-31. (canceled)

32. The network according to claim 28, wherein the particular one or ones of the base stations receiving the beam from the antenna arrangement is adapted to receive radio beams arriving in a generally vertical direction.

33. The network according to claim 28, wherein the antenna arrangement is associated with a transceiving station carried by the aircraft and with which the user terminals on the aircraft can communicate.

34. The network according to claim 33, wherein the transceiving station is at least one of: a base station and a repeater station.

35. (canceled)

36. The system according to claim 1, wherein the at least one antenna arrangement is adjusted in dependence on an altitude of the at least one antenna arrangement so that, irrespective of the altitude, a terrestrial footprint of the beam is the same.

37. The system according to claim 1, wherein a terrestrial footprint of the beam is defined so that signals from the at least one antenna arrangement are only received by a restricted number of terrestrially based transceiving stations.

38. The system according to claim 1, wherein the at least one antenna arrangement transmits a signal specifying an altitude of the user terminal.

39. The method according to claim 15, wherein the radiation beam for providing the link is produced by an antenna arrangement.

40. The method according to claim 39, further comprising:
adjusting the antenna arrangement in dependence on an altitude of the antenna arrangement so that, irrespective of the altitude, a terrestrial footprint of the beam is the same.

41. The method according to claim 39, further comprising:
defining a terrestrial footprint of the beam so that signals from the antenna arrangement are only received by a restricted number of terrestrially based transceiving stations.

42. The method according to claim 39, further comprising:
transmitting a signal from the antenna arrangement specifying an altitude of the user terminal.
